(19) United States
(12) Patent Application Publication
(10) Pub. No.: US 2026/0015271 A1
(43) Pub. Date: Jan. 15, 2026

(54) METHOD FOR IMPROVING CALCIUM CARBONATE SCALE INHIBITOR EFFICIENCY

(71) Applicant: Saudi Arabian Oil Company, Dhahran (SA)

(72) Inventors: Tawfik Al-Ghamdi, Dammam (SA); Sultan H. Alsubaie, Dhahran (SA); Qiwei Wang, Dhahran (SA)

(21) Appl. No.: 18/768,540

(22) Filed: Jul. 10, 2024

(51) Int. Cl. C02F 5/14; C02F 5/12; C02F 103/10; E21B 37/06

(52) U.S. Cl. CPC C02F 5/14; C02F 5/12; E21B 37/06; C02F 2103/10

(57) ABSTRACT

This technology relates to a system and method of delaying CaCO₃ scale formation in an oil production well using a phosphonate scale inhibitor and a chelating agent. The addition of a small concentration (less than 5 ppm) of a chelating agent to the phosphonate scale inhibitor delays the scale induction time and scaling time of CaCO₃ scale.

### TECHNICAL FIELD

This disclosure relates to a method of improving calcium carbonate scale inhibitor efficiency using a chelating agent along with a scale inhibitor.

### BACKGROUND

Natural water and produced water in oil and gas fields contain high concentrations of calcium and bicarbonate. Changes in physical conditions, such as pressure and temperature, can shift the chemical equilibrium enough, leading to water becoming supersaturated with calcium carbonate (CaCO₃), which can then form scale. Formation of CaCO₃ scale is a common phenomenon in the oil and gas production and refining processes. Scale deposits can damage equipment such as heat exchangers, cooling systems, and membrane filtration units. This reduces productivity and can interrupt the process due to solid formation. Heavy scale deposition can result in complete production well shutdown. Scaling rate increases sharply with the increase of water production in mature wells. Cleaning up scale requires considerable capital, operating, and maintenance cost, unless managed effectively.

The use of scale inhibitors (also known as threshold inhibitors) has been the most viable approach to prevent carbonate scale deposition in oil production and refinery operations. The performance of these scale inhibitors against carbonate scale formation is affected by several factors, such as water composition, pH, temperature, suspended solids, trace elements, and the presence of other chemicals. High performance (inhibition efficacy) is the most important criteria in the selection of a scale inhibitor product for oil field applications. However, current scale inhibitor products are applied at high dosages to prevent scale formation.

### SUMMARY

The present disclosure provides a method for delaying CaCO₃ scale formation. In some implementations, the methods include adding a phosphonate scale inhibitor to a synthetic produced water; adding a chelating agent to the phosphonate scale inhibitor in the synthetic produced water, where the chelating agent includes a polyamino-polycarboxylic ligand selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), diethylenetriamine pentaacetic acid (DTPA), and hydroxyethyl ethylenediamine triacetic acid (HEDTA); flowing the synthetic produced water through a capillary tube in an oven at a user defined temperature and a user defined pressure; measuring a pressure difference (ΔP) as a function of time during the flow of the synthetic produced water through the capillary tube in the oven; and determining a scale induction time and a scaling time from the pressure difference, where adding the chelating agent to the phosphonate scale inhibitor delays the scale induction time and scaling time.

In some implementations, the phosphonate scale inhibitor includes amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

In some implementations, the concentration of the chelating agent added to the phosphonate scale inhibitor is less than 5 ppm.

In some implementations, the chelating agent includes hydroxyethyl ethylenediamine triacetic acid (HEDTA).

In some implementations, the scale induction time and scaling time is delayed by 1.3 to 10 times as compared to a method that does not include the chelating agent.

In some implementations, the user defined temperature is between 25-250 ° C.

In some implementations, the user defined pressure is between 0.34-20.7 MPa.

In some implementations, the method includes determining the scale induction time when measuring an increase in the ΔP from a baseline value of negligible ΔP.

In some implementations, the method includes determining the scaling time when measuring the ΔP of 6.89×10⁻³ MPa.

Implementations described here provide an integrated system to measure a delay in CaCO₃ scale formation. In some implementations, the integrated system includes a pump system to pump a mixture of synthetic brines, the pump system includes a first pump that includes a synthetic cation brine; a second pump, placed parallel to the first pump, that includes a synthetic anion brine; and a third pump placed parallel to the second pump and the first pump that includes the synthetic anion brine, where the synthetic anion brine includes a phosphonate scale inhibitor and a chelating agent; an oven, set at a user defined temperature; a pre-heating coil placed inside the oven which is configured to receive the mixture of synthetic brines from the pump system; a mixing chamber placed downstream of the pre-heating coil inside the oven, configured to receive the mixture of synthetic brines from the pre-heating coil; a capillary coiled tube placed downstream of the mixing chamber in the oven, which is configured to receive the mixture of synthetic brines from the mixing chamber; and a back-pressure system, set at a user defined pressure.

In some implementations, a pressure difference is measured across the capillary coiled tube as a function of time.

In some implementations, a delay in the increase of the pressure difference is indication of a scaling induction time, which further indicates delay in CaCO₃ scale formation.

In some implementations, the pressure difference of 6.89×10⁻³ MPa indicates a scaling time.

In some implementations, the scale inhibitor in the third pump includes amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

In some implementations, the chelating agent in the third pump includes hydroxyethyl ethylenediamine triacetic acid (HEDTA).

In some implementations, the concentration of the chelating agent is between 0.1-8 ppm.

Implementations described here provide a method to delay CaCO₃ scale formation in an oil production well. In some implementations the method includes adding an additive, which includes a chelating agent, to a scale inhibitor in a produced water stream from the oil production well.

In some implementations, the chelating agent includes a polyamino-polycarboxylic ligand selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), diethylenetriamine pentaacetic acid (DTPA), or hydroxyethyl ethylenediamine triacetic acid (HEDTA).

In some implementations, the additive includes less than 5 ppm of the chelating agent.

In some implementations, the scale inhibitor includes amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

### BRIEF DESCRIPTION OF DRAWINGS

FIG. 1 is a schematic drawing of an exemplary dynamic tube loop test.

FIG. 2 is the chemical structure of hydroxyethyl ethylenediamine triacetic acid (HEDTA).

FIG. 3 is a graph showing the test results from an exemplary dynamic loop test.

FIG. 4A is a graph showing the test results of a dynamic loop test performed without the use of HEDTA.

FIG. 4B is a graph showing the test results of a dynamic loop test performed using 0.5 ppm HEDTA.

FIG. 4C is a graph showing the test results of a dynamic loop test performed using 1 ppm HEDTA.

FIG. 4D is a comparison of the test results of dynamic loop tests performed without HEDTA or 0.5 ppm or 1 ppm HEDTA.

FIG. 5 illustrates the effect on scaling using various concentrations of HEDTA and 3 ppm KT-126 (a scale inhibitor).

FIG. 6 illustrates the effect on scaling using various concentrations of HEDTA and 4 ppm SCW22127 (a scale inhibitor).

FIG. 7 is a process flow diagram illustrating how to measure CaCO₃ scale formation using a dynamic tube loop test of the present disclosure.

### DETAILED DESCRIPTION

Organic phosphates, either phosphonates or phosphate esters, are the most commonly used scale inhibitors to control carbonate scale formation in oil well operations. They are organophosphorus compounds based on phosphonic acids (—PO(OH)₂). The present disclosure describes phosphonate compounds that are used as scale inhibitors. Examples of such phosphonate compounds include, but are not limited to, amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), and 2-phosphonobutane-1,2,4-tricarboxylic acid (PBTC). Phosphate esters also are used as scale inhibitors and have calcium tolerance. These compounds include, but are not limited to, triethanolamine phosphate ester, hydroxyamine phosphate ester, and polyhydric alcohol phosphate ester.

Provided in the present disclosure are methods of using a chelating agent as an additive to a scale inhibitor for reducing or delaying the formation of scale in a subterranean formation. In some implementations, the chelating agent enhances the performance of a phosphate-based inhibitor for preventing CaCO₃ scale formation. In some implementations, the chelating agent includes a polyamino-polycarboxylic ligand. In some implementations, the polyamino-polycarboxylic ligand is selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), and diethylenetriamine pentaacetic acid (DTPA). In some implementations, the chelating agent is the phosphorous-free additive HEDTA. HEDTA is low in cost and has a lower environmental impact than organic phosphate inhibitors, such as those commonly used to prevent scale.

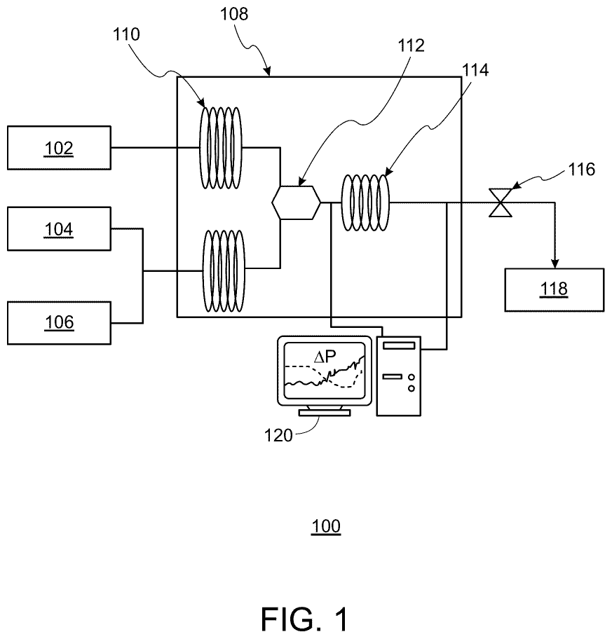

FIG. 1 is a schematic drawing of a dynamic tube loop test 100. The effect of HEDTA along with several phosphonate scale inhibitors on scaling can be demonstrated by a series of scale inhibition tests. Tests are conducted using a dynamic tube blocking method (also known as dynamic tube loop test), under simulated oil field conditions in the Ghawar field. The wellhead temperature at the Ghawar field ranges between 60-100° C. and pressure ranges between 300-600 psi (2.07-4.14 MPa). The Ghawar field has a produced water composition as listed in Table 1.

Three pumps containing synthetic brine were used. Pump A 102 included a cation brine, pump B 104 included an anion brine, and pump C 106 included an anion brine along with a scale inhibitor. Table 2 lists the composition used for the cation and anion brine. The cation and anion brine compositions were prepared based on the produced water composition as found in the field (for example, the produced water composition is listed in Table 1).

TABLE 1
Produced water composition used in lab tests.

| Parameter | (mg/L) |
|---|---|
| Na⁺ | 6911 |
| K⁺ | 881 |
| Ca²⁺ | 5524 |
| Mg²⁺ | 551 |
| Sr²⁺ | 188 |
| HCO₃⁻ | 603 |
| Cl₋ | 22300 |
| SO₄²⁻ | 450 |

TABLE 2
Salts used to prepare synthetic brines

| | (g/L) |
|---|---|
| Cation brine | |
| NaCl | 16.44 |
| MgCl₂•6H₂O | 9.22 |
| KCl | 3.36 |
| CaCl₂•2H₂O | 40.52 |
| SrCl₂•6H₂O | 1.10 |
| Anion brine | |
| NaCl | 16.44 |
| NaHCO₃ | 1.66 |
| Na₂SO₄ | 1.33 |

The brines from the three pumps were flowed into an oven 108. The oven 108 was equipped with a pre-heating coil 110. The pre-heating coil 110 received the brine from the pumps and the temperature of the brine was raised to a user defined value. In some implementations, the user defined value for temperature ranges between 25-250° C. The user defined pressure ranges between 50-3000 psi (0.34-20.7 MPa). In some implementations, the temperature of the pre-heating coil 110 was maintained at 80° C. Once the brines reached the user defined temperature, they were comingled in a mixing chamber 112, resulting in a mixed stream. The mixed stream was flowed through a monel capillary coiled tube 114 (capillary tube). The capillary tube has a uniform internal diameter of 1 mm.

The pressure difference (ΔP) across the capillary tube was consistently monitored during test runs. The ΔP and flow rate values were recorded dynamically by a computer device 120. A back-pressure system 116 was fitted at the outlet of the capillary tube. In some implementations, the pressure of the system is 300-600 psi (2.07-4.14 MPa). In some implementations, the pressure of the system was maintained at 500 psi (3.4 MPa). The outflow fluids 118 were collected in a beaker outside the oven. In some implementations, the outflow fluids 118 were further analyzed to determine inhibitor concentrations. During the test runs, the combined flow rate for pump B 104 and pump C 106 was kept at 5 mL/min, which was equal to the flow rate of pump A 102. The scale inhibitor concentration was controlled by varying the flow rates from pumps B and C.

The formation of scale deposit was indicated by the increase in ΔP due to a reduced cross-sectional area in the capillary tube. At the end of each run, the capillary tube was cleaned with 10% acetic acid for 20 minutes, followed by distilled water for 30 minutes, to completely remove CaCO₃ blockage and residual inhibitor.

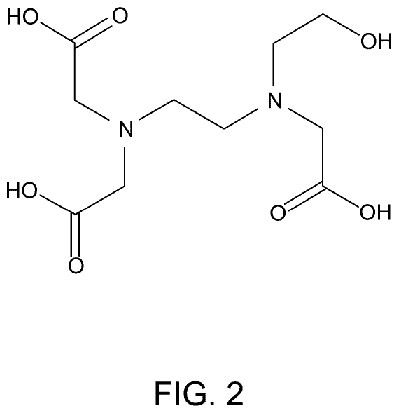

FIG. 2 shows the chemical structure of HEDTA. In the methods of the present disclosure, HEDTA is used as an additive along with a phosphate-based scale inhibitor to delay the formation of CaCO₃ scale. In some implementations, HEDTA is used as a chelating agent which dissolves the formed scale. Typically, chelating agents are used in high concentrations (>10% in concentration) and in batch treatments to dissolve scale deposition. Whereas in implementations here, when HEDTA is used as an additive along with a phosphonate scale inhibitor, only a small concentration of HEDTA (<5 ppm) is required to prevent or delay CaCO₃ scale formation.

Chelating agents such as HEDTA are limited in their application as a scale inhibitor when used alone. For example, the use of such a chelating agent is limited to water with very low concentration of calcium (<50 ppm). Without wishing to be bound by any particular theory, it is believed to be because the reaction is stochiometric, i.e., one chelating agent molecule is needed for each calcium molecule. For example, oil field brines can have high calcium concentrations (5000-30,000 ppm of calcium). To remove the calcium, an equal molar amount of HEDTA is needed in water. This can be equivalent to approximately 34,750 ppm of HEDTA. The use of a chelating agent alone as a scale inhibitor is not practical or economical.

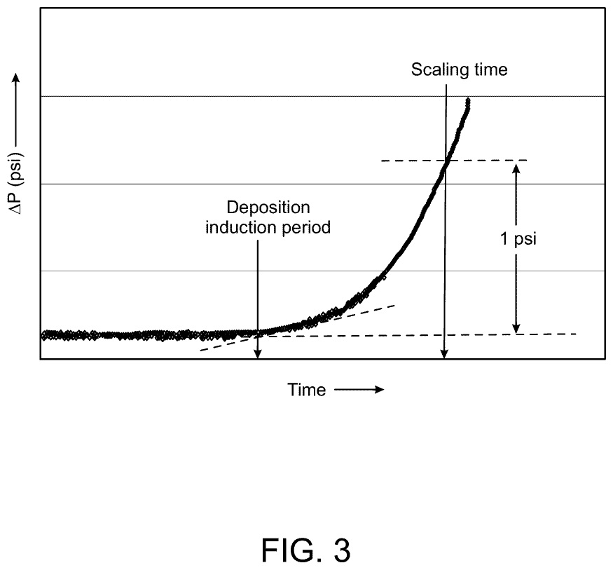

FIG. 3 is a graph showing the test results from an exemplary dynamic loop test as described in FIG. 2. Scale induction time (t_{ind}) is defined as the time taken for ΔP to start increasing from a baseline value of negligible ΔP (˜0 psi). This indicates that a measurable amount of scale has accumulated in the capillary tube. Scaling time (t_{scaled}) is the time taken for ΔP increase to reach 1 psi. This indicates a significant amount of scale deposited in the capillary tube. The degree of delay in ΔP can be used to judge the effectiveness of scale inhibitors. The more effective the scale inhibitor is, the slower the scale formation, the longer the scale induction time, and the longer the scaling time. The temperature and pressure can affect the scale induction time and scaling time.

Table 3 lists the test runs that were conducted by the dynamic loop method to interpret CaCO₃ scaling induction time and scaling time. Two commercial phosphonate scale inhibitors were used in the test runs. The phosphonate scale inhibitors were added at certain concentrations (listed in Table 3) to the synthetic brine in pump C. In several test runs, a small concentration (<2 ppm) of HEDTA was added as an additive to the phosphonate scale inhibitor. The phosphonate scale inhibitors used were ATMP based Gyptron KT-126 (from ChampionX) and DETPMP based SCW22127 (from Baker Hughes). For the test runs, 3ppm of Gyptron KT-126 was used and 4 ppm of SCW22127 was used. In some implementations, the concentration of the phosphonate scale inhibitors varies between 1-7 ppm. In some implementations, the concentration of HEDTA as an additive varies between 0.2-6 ppm. In some implementations, phosphonate scale inhibitors include BHPMP, HDTMP, EDTMP, HEDP, PAPEMP, PBTC, or phosphate esters.

TABLE 3
Summary of test runs to interpret the effect
of HEDTA on scale inhibitor efficiency.

| Test run | Scale inhibitor | HEDTA | |
|---|---|---|---|
| #1 | None | None | |
| #2 | | 0.5 | ppm |
| #3 | | 1 | ppm |
| #4 | 3 ppm KT-126 | None | |
| #5 | | 0.5 | ppm |
| #6 | | 1 | ppm |
| #7 | 4 ppm SCW22127 | None | |
| #8 | | 0.5 | ppm |

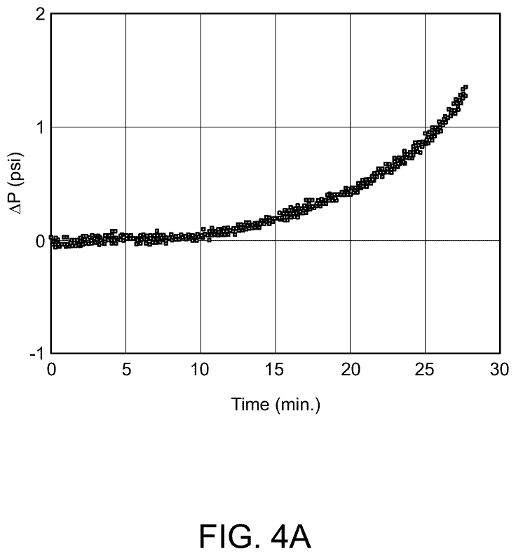

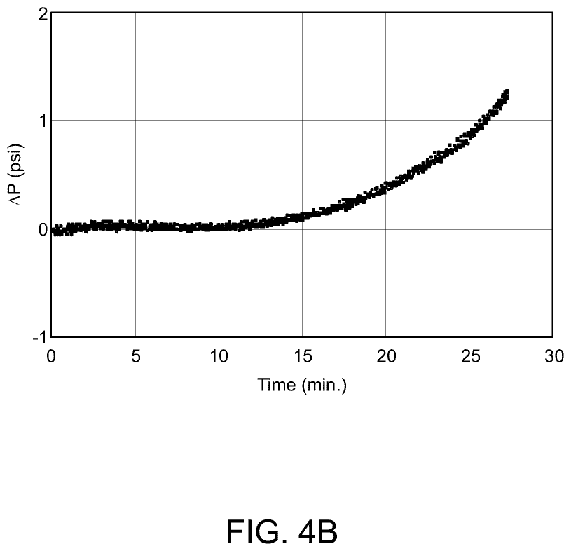

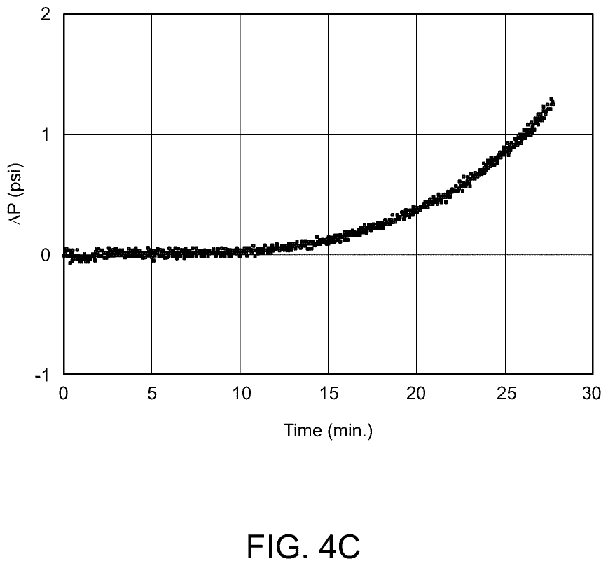

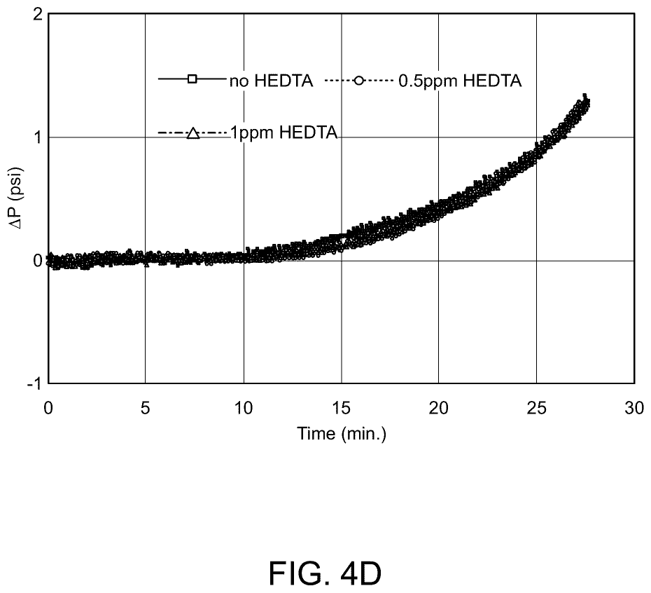

FIG. 4A shows the test results of the dynamic loop test with no HEDTA (Run #1). In Run #1, the synthetic brine in pump C had no scale inhibitor or HEDTA. Pump A and pump B had the same synthetic brine composition as described in FIG. 1. The composition of the synthetic brine is listed in Table 2. From the graph, it was observed that the scale induction time was ˜12 min and the scaling time was ˜26 min.

FIG. 4B shows the test results of the dynamic loop test with 0.5 ppm HEDTA (Run #2). In Run #2, the synthetic brine in pump C included 0.5 ppm of HEDTA. No scale inhibitor was added to the synthetic brine in pump C. Pump A and pump B had the same synthetic brine composition as listed in Table 2. From the graph, it was observed that the scale induction time was ˜12 min and the scaling time was ˜26 min.

FIG. 4C shows the test results of the dynamic loop test with 1 ppm HEDTA (Run #3). In Run #3, the synthetic brine in pump C included 1 ppm of HEDTA. No scale inhibitor was added to the synthetic brine in pump C. Pump A and pump B had the same synthetic brine composition as listed in Table 2. From the graph, it was observed that the scale induction time was ˜12 min and the scaling time was ˜26 min.

FIG. 4D is a comparison of the test results of the dynamic loop tests (Runs #1, #2, #3). The test results from Runs #1, #2, #3 show that HEDTA by itself had no impact on CaCO₃ scaling in the capillary tube. In all three test runs, the scale induction time was ˜12 min and the scaling time was ˜26 min. This shows that even an increase in the concentration of HEDTA had no impact on CaCO₃ scaling.

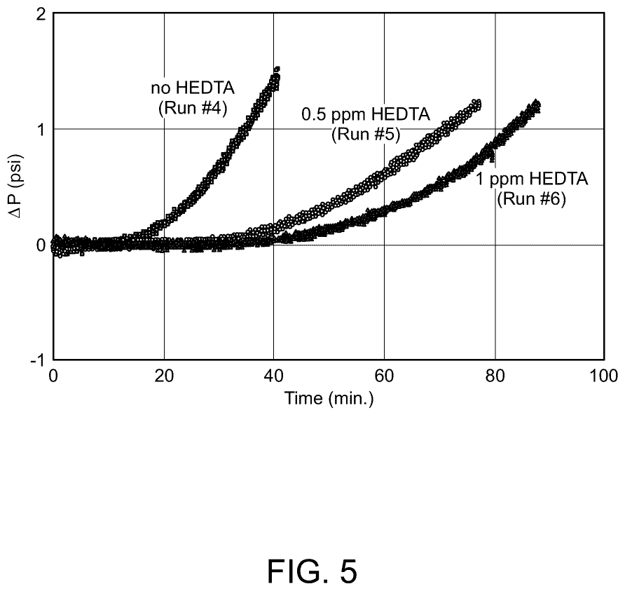

FIG. 5 shows the test results of the effect of HEDTA and 3 ppm KT-126 on CaCO₃ scaling. The scale inhibitor KT-126 and HEDTA were added to the synthetic brine in pump C. With 3 ppm of KT-126 alone, the CaCO₃ scaling was delayed slightly when compared to the scaling delay using HEDTA alone. The scale induction time and the scaling time were 15 min and 35 min, respectively. With 0.5 ppm of HEDTA added to 3 ppm of KT-126, the scale induction time was extended to 32 min and the scaling time was delayed to 71 min, respectively. With 1 ppm of HEDTA added to 3 ppm of KT-126, the scaling rate was further decreased. The scale induction time and the scaling time were further delayed to 44 min and 84 min, respectively.

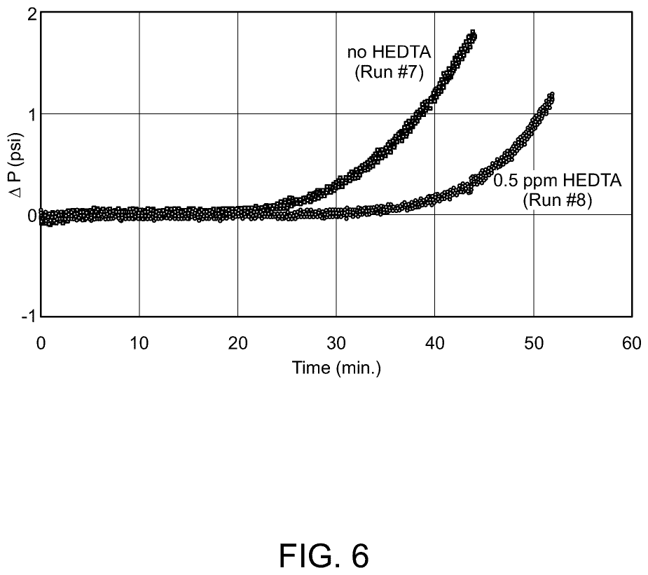

FIG. 6 shows the test results of the effect of HEDTA and 4 ppm SCW22127 on CaCO₃ scaling. Without HEDTA added to 4 ppm of SCW22127, the scale induction time and the scaling time were 21 min and 39 min, respectively. With 0.5 ppm of HEDTA added to SCW22127, the scale induction time was extended to 33 min and the scaling time was extended to 51 min. Table 4 shows a summary of the dynamic loop test results for the two phosphonate scale inhibitors. Table 4 also shows the summary of the dynamic loop test results on CaCO₃ scaling, when small concentrations of HEDTA (concentrations such as 0.1-5 ppm) were added to the phosphonate scale inhibitors. The results show that the scaling induction time and the scaling time were delayed by 1.3-3 times as compared to the test results without HEDTA. In some implementations, the scaling induction time and the scaling time is delayed by a factor of 1.3-10, when compared to the cases without HEDTA. The delay in scaling induction time and scaling time is a function of the concentration of HEDTA used.

TABLE 4
Summary of dynamic tube loop test results showing the effect
of HEDTA and the scale inhibitors on CaCO₃ scaling.

| | | Scale | |
|---|---|---|---|
| | | induction | Scaling time |
| Inhibitor | HEDTA | time (min.) | (min.) |
| 3 ppm | No HEDTA | 15 | 35 |
| KT-126 | 0.5 ppm | 32 | 71 |
| | HEDTA | | |
| | 1 ppm HEDTA | 44 | 84 |
| 4 ppm | No HEDTA | 21 | 39 |
| SCW22127 | 0.5 ppm | 33 | 51 |
| | HEDTA | | |

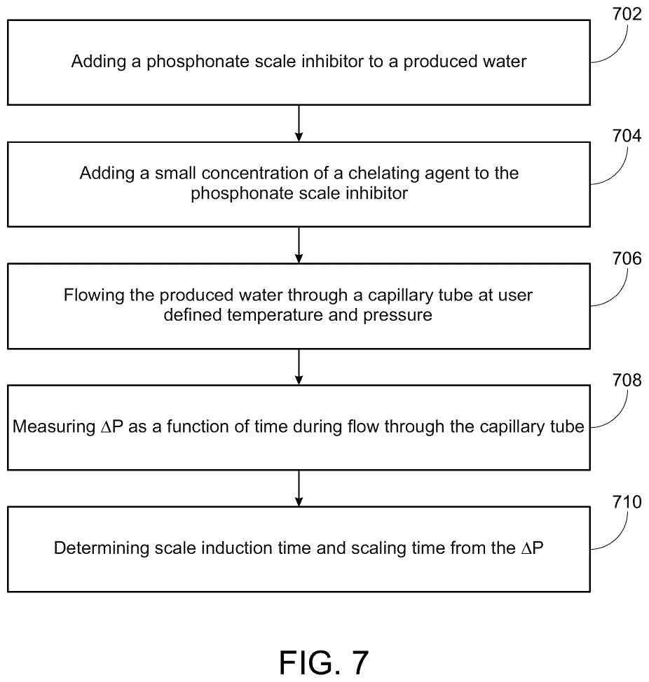

FIG. 7 is a process flow diagram showing how to measure CaCO₃ scale formation using a dynamic tube loop test according to the methods of the present disclosure. At block 702, a phosphonate scale inhibitor is added to a produced water. In some implementations, the concentration of scale inhibitor is between 1-15 ppm. The produced water composition includes several divalent cations and anions. In some implementations, the calcium and magnesium in the produced water interact with bicarbonate ions and form calcium and magnesium carbonates. In some implementations, the calcium carbonate scale formation is measured in the presence of phosphonate scale inhibitors. In some implementations, the scale inhibitors include BHPMP, HDTMP, EDTMP, HEDP, PAPEMP, PBTC, ATMP, DETPMP, or phosphate esters.

At block 704, a small concentration of a chelating agent is added to the phosphonate scale inhibitor. For example, the chelating agents can include nitrilo triacetic acid (NTA), hydroxyethylimino diacetic acid (HEIDA), ethylenediamine tetraacetic acid (EDTA), hydroxyethylethylenediamine triacetic acid (HEDTA), diethylenetriamine pentaacetic acid (DTPA). In some implementations, HEDTA is used as the chelating agent. In some implementations, the concentration of chelating agent is between 0.1-8 ppm.

At block 706, the produced water that includes the phosphonate scale inhibitor and the chelating agent is flowed through a capillary tube at a user defined temperature and pressure. In some implementations, the temperature ranges between 25-250° C. and the pressure ranges between 50-3000 psi.

At block 708, the pressure difference is measured as the function of time as the produced water flows through the capillary tube. The time at which the pressure difference shows an increase is measured as the scale induction time. This indicates that some amount of CaCO₃ scale is formed in the tube. When the pressure difference rises to 1 psi, it indicates that a significant amount of CaCO₃ scale formation has occurred. This is measured as the scaling time.

At block 710, the scale induction time and the scaling time are measured. The effect of different concentrations of the chelating agent and the phosphonate scale inhibitors on scaling are observed. In some implementations, a small concentration of the chelating agent HEDTA can delay the CaCO₃ scale induction time and scaling time by 1.3-3 times when compared to the case when only the scale inhibitor is added without the chelating agent.

An implementation of the present disclosure includes a method to improve CaCO₃ scale inhibitor efficiency. In some implementations, the method involves adding a phosphonate scale inhibitor to a synthetic produced water. A small concentration such as 0.5-5 ppm of a chelating agent is added as an additive to the phosphonate scale inhibitor to delay the formation of CaCO₃ scale formation. The concentration is measured relative to the calcium concentration in the synthetic produced water. The phosphonate scale inhibitors can include BHPMP, HDTMP, EDTMP, HEDP, PAPEMP, PBTC, ATMP, DETPMP, or phosphate esters. The chelating agent can include polyamino-polycarboxylic ligands selected from NTA, HEIDA, EDTA, HEDTA, or DTPA. In some implementations, HEDTA is used as an additive along with the phosphonate scale inhibitor in synthetic produced water.

In some implementations, the synthetic brine that includes the scale inhibitor and chelating agent flows through a capillary tube. A pressure difference is measured as a function of time during flow through the capillary tube. A scale induction and a scaling time are determined from the pressure difference and time data. Test results show that the addition of less than 5 ppm of HEDTA delays the CaCO₃ scale induction time and scaling time by 1.3-3 times, when compared to the scale induction time and scaling time of the inhibitor without the addition of HEDTA.

Also provided in the present disclosure is a system to measure CaCO₃ scale formation delay. The system includes a pump system through which a mixture of synthetic brine is pumped. The pump system includes three pumps. The first pump includes a synthetic cation brine, the second pump includes a synthetic anion brine, and the third pump includes the synthetic anion brine which includes a phosphonate scale inhibitor and a small concentration of the chelating agent. In some implementations, less than 5 ppm of HEDTA is used as the chelating agent. Additionally, the system includes an oven, a pre-heating coil, a mixing chamber placed downstream of the pre-heating coil inside the oven, a capillary coiled tube placed downstream of the mixing chamber, and a back-pressure system.

Also provided in the present disclosure is a method to delay CaCO₃ scale formation in an oil production well by adding a small concentration of an additive to a scale inhibitor in the produced water from the oil production well. The additive includes less than 5 ppm of HEDTA. The scale inhibitors include amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

Other implementations are also within the scope of the following claims.

### Exemplary Embodiments

The exemplary embodiments include:
1. A method of delaying a calcium carbonate (CaCO₃) scale formation comprising:
   adding a phosphonate scale inhibitor to a synthetic produced water;
   adding a chelating agent to the phosphonate scale inhibitor in the synthetic produced water, wherein the chelating agent comprises a polyamino-polycarboxylic ligand selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), diethylenetriamine pentaacetic acid (DTPA), and hydroxyethyl ethylenediamine triacetic acid (HEDTA)
   flowing the synthetic produced water through a capillary tube in an oven at a user defined temperature and a user defined pressure;
   measuring a pressure difference (ΔP) as a function of time, during the flow of the synthetic produced water through the capillary tube in the oven; and
   determining a scale induction time and a scaling time from the ΔP, wherein adding the chelating agent to the phosphonate scale inhibitor delays the scale induction time and the scaling time.
2. The method of embodiment 1, wherein the phosphonate scale inhibitor comprises amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.
3. The method of embodiment 1 or 2, wherein a concentration of the chelating agent added to the phosphonate scale inhibitor is less than 5 ppm.
4. The method of any of embodiments 1 to 3, wherein the chelating agent comprises hydroxyethyl ethylenediamine triacetic acid (HEDTA).
5. The method of any of embodiments 1 to 4, wherein the scale induction time and scaling time is delayed by 1.3 to 10 times as compared to a method that does not include the chelating agent.
6. The method of any of embodiments 1 to 5, wherein the user defined temperature is between 25-250° C.
7. The method of any of embodiments 1 to 6, wherein the user defined pressure is between 0.34-20.7 MPa.
8. The method of any of embodiments 1 to 7, further comprising determining the scale induction time when measuring an increase in the ΔP from a baseline value of negligible ΔP.
9. The method of any of embodiments 1 to 8, further comprising determining the scaling time when measuring the ΔP of 6.89×10⁻³ MPa.
10. An integrated system to measure calcium carbonate (CaCO₃) scale formation delay comprising:
   a pump system to pump a mixture of synthetic brines, the pump system comprising:
      a first pump comprising a synthetic cation brine;
      a second pump placed parallel to the first pump, comprising a synthetic anion brine; and
      a third pump placed parallel to the second pump and the first pump, comprising the synthetic anion brine, wherein the synthetic anion brine comprises a phosphonate scale inhibitor and a chelating agent;
   an oven, set at a user defined temperature;
   a pre-heating coil placed inside the oven, which is configured to receive the mixture of synthetic brines from the pump system;
   a mixing chamber placed downstream of the pre-heating coil inside the oven, which is configured to receive the mixture of synthetic brines from the pre-heating coil;
   a capillary coiled tube placed downstream of the mixing chamber in the oven, which is configured to receive the mixture of synthetic brines from the mixing chamber; and
   a back-pressure system, set at a user defined pressure.
11. The integrated system of embodiment 10, wherein a pressure difference is measured across the capillary coiled tube as a function of time.
12. The integrated system of embodiment 10 or 11, wherein a delay in the increase of the pressure difference is indication of a scaling induction time, which further indicates delay in CaCO₃ scale formation.
13. The integrated system of any of embodiments 10 to 12, wherein the pressure difference of 6.89×10⁻³ MPa indicates a scaling time.
14. The integrated system of any of embodiments 10 to 13, wherein the scale inhibitor in the third pump comprises amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.
15. The integrated system of any of embodiments 10 to 14, wherein the chelating agent in the third pump comprises hydroxyethyl ethylenediamine triacetic acid (HEDTA).
16. The integrated system of any of embodiments 10 to 15, wherein the concentration of the chelating agent is between 0.1-8 ppm.
17. A method to delay calcium carbonate (CaCO₃) scale formation in an oil production well comprising:
   adding an additive comprising a chelating agent to a scale inhibitor in a produced water stream from the oil production well.
18. The method of embodiment 17, wherein the chelating agent comprises a polyamino-polycarboxylic ligand selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), diethylenetriamine pentaacetic acid (DTPA), and hydroxyethyl ethylenediamine triacetic acid (HEDTA).
19. The method of embodiment 17 or 18, wherein the additive comprises less than 5 ppm of the chelating agent.
20. The method of any of embodiments 17 to 19, wherein the scale inhibitor comprises amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

What is claimed is:

1. A method of delaying a calcium carbonate (CaCO₃) scale formation comprising:
adding a phosphonate scale inhibitor to a synthetic produced water;
adding a chelating agent to the phosphonate scale inhibitor in the synthetic produced water, wherein the chelating agent comprises a polyamino-polycarboxylic ligand selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), diethylenetriamine pentaacetic acid (DTPA), and hydroxyethyl ethylenediamine triacetic acid (HEDTA);
flowing the synthetic produced water through a capillary tube in an oven at a user defined temperature and a user defined pressure;
measuring a pressure difference (ΔP) as a function of time during the flow of the synthetic produced water through the capillary tube in the oven; and
determining a scale induction time and a scaling time from the ΔP, wherein adding the chelating agent to the phosphonate scale inhibitor delays the scale induction time and the scaling time.

2. The method of claim 1, wherein the phosphonate scale inhibitor comprises amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

3. The method of claim 1, wherein a concentration of the chelating agent added to the phosphonate scale inhibitor is less than 5 ppm.

4. The method of claim 3, wherein the chelating agent comprises hydroxyethyl ethylenediamine triacetic acid (HEDTA).

5. The method of claim 1, wherein the scale induction time and scaling time is delayed by 1.3 to 10 times as compared to a method that does not include the chelating agent.

6. The method of claim 1, wherein the user defined temperature is between 25-250° C.

7. The method of claim 1, wherein the user defined pressure is between 0.34-20.7 MPa.

8. The method of claim 1, further comprising determining the scale induction time when measuring an increase in the ΔP from a baseline value of negligible ΔP.

9. The method of claim 1, further comprising determining the scaling time when measuring the ΔP of 6.89×10⁻³ MPa.

10. An integrated system to measure a delay in calcium carbonate (CaCO₃) scale formation comprising:
a pump system to pump a mixture of synthetic brines, the pump system comprising:
a first pump comprising a synthetic cation brine;
a second pump placed parallel to the first pump, comprising a synthetic anon brine; and
a third pump placed parallel to the second pump and the first pump, comprising the synthetic anion brine, wherein the synthetic anion brine comprises a phosphonate scale inhibitor and a chelating agent;
an oven, set at a user defined temperature;
a pre-heating coil placed inside the oven, which is configured to receive the mixture of synthetic brines from the pump system;
a mixing chamber placed downstream of the pre-heating coil inside the oven, which is configured to receive the mixture of synthetic brines from the pre-heating coil;
a capillary coiled tube placed downstream of the mixing chamber in the oven, which is configured to receive the mixture of synthetic brines from the mixing chamber; and
a back-pressure system, set at a user defined pressure.

11. The integrated system of claim 10, wherein a pressure difference is measured across the capillary coiled tube as a function of time.

12. The integrated system of claim 11, wherein a delay in the increase of the pressure difference is indication of a scaling induction time, which further indicates delay in CaCO₃ scale formation.

13. The integrated system of claim 12, wherein the pressure difference of 6.89×10⁻³ MPa indicates a scaling time.

14. The integrated system of claim 10, wherein the scale inhibitor in the third pump comprises amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.

15. The integrated system of claim 10, wherein the chelating agent in the third pump comprises hydroxyethyl ethylenediamine triacetic acid (HEDTA).

16. The integrated system of claim 15, wherein the concentration of the chelating agent is between 0.1-8 ppm.

17. A method to delay calcium carbonate (CaCO₃) scale formation in an oil production well comprising:
adding an additive comprising a chelating agent to a scale inhibitor in a produced water stream from the oil production well.

18. The method of claim 17, wherein the chelating agent comprises a polyamino-polycarboxylic ligand selected from nitrilo triacetic acid (NTA), hydroxyethylimino diacetic acid (HEIDA), ethylenediamine tetraacetic acid (EDTA), hydroxyethyl ethylenediamine triacetic acid (HEDTA), diethylenetriamine pentaacetic acid (DTPA), and hydroxyethyl ethylenediamine triacetic acid (HEDTA).

19. The method of claim 17, wherein the additive comprises less than 5 ppm of the chelating agent.

20. The method of claim 17, wherein the scale inhibitor comprises amino trimethylene phosphonate (ATMP), bishexamethylene triamine pentamethylene phosphonate (BHPMP), hexamethylenediamine tetramethylene phosphonate (HDTMP), diethylenetriamine pentamethylene phosphonate (DETPMP), ethylene diamine tetramethylene phosphonate (EDTMP), 1-hydroxyethylidene-1,1-diphosphonate (HEDP), polyamino polyether methylene phosphonate (PAPEMP), 2-phosphonobutane-1,2,4-tricarboxylic acid (PBTC), or phosphate esters.
